(19) United States
(12) Patent Application Publication
(10) Pub. No.: US 2021/0271328 A1
(43) Pub. Date: Sep. 2, 2021

(54) VIRTUAL INPUT DEVICES

(71) Applicant: Hewlett-Packard Development Company, L.P., Spring, TX (US)

(72) Inventors: Hai Qi Xiang, Houston, TX (US); Dimitre D. Mehandjiysky, Spring, TX (US)

(73) Assignee: Hewlett-Packard Development Company, L.P., Spring, TX (US)

(21) Appl. No.: 17/267,833

(22) PCT Filed: Nov. 19, 2018
(86) PCT No.: PCT/US2018/061788

§ 371 Date: Feb. 11, 2021

(51) Int. Cl. G06F 3/01; G06F 3/042

(52) U.S. Cl. CPC G06F 3/017; G06F 3/0425; G06F 3/011

(57) ABSTRACT

In example implementations, an electronic device is provided. The electronic device includes a sensor, and a processor. The sensor is to detect a movement of a hand of a user controlling a virtual input device. The processor is communicatively coupled to the sensor. The processor is to translate the movement of the hand of the user detected by the sensor into a control input to the electronic device and to execute the control input.

### BACKGROUND

Computers have input devices connected to them to allow a user to provide inputs to the computer. For example, a mouse or a trackpad may be used to control a cursor on a display of the electronic device. The movement of the mouse or movement detected by the trackpad may correspond to movement of the cursor on the display. The mouse or the trackpad may include additional functionality to make selections, bring up different menus, navigate windows that are displayed, and the like.

The mouse and the track pad may use a power source to operate the mouse or the track pad. For example, the power source may be a battery or a physical connection to the electronic device to receive power from the electronic device. The mouse or the track pad may have a body made out of a hard material such as plastic. The body may contain various electronic components that enable the mouse or trackpad to connect to the main electronic device wirelessly, or using an antenna and a wired connection. The electronic components may allow the mouse or trackpad to execute the desired inputs or movements initiated by a user.

### BRIEF DESCRIPTION OF THE DRAWINGS

FIG. 1 is a block diagram of an example electronic device with a virtual input device of the present disclosure;

FIG. 2 is a block diagram of an example operation of the electronic device with the virtual input device of the present disclosure;

FIG. 3 is a block diagram of an example electronic device with a sensor to detect the virtual input device of the present disclosure;

FIG. 4 is a flow chart of an example method for operating a virtual input device of the present disclosure; and

FIG. 5 is a block diagram of an example non-transitory computer readable storage medium storing instructions executed by a processor to operate a virtual input device of the present disclosure.

### DETAILED DESCRIPTION

Examples described herein provide a device with a virtual input device. As noted above, input devices such as a mouse or a track pad can be used to control a cursor on a display or provide input to the device to provide a selection, bring up menus, scroll through windows, and the like. The mouse or track pad may be a physical device that is connected to the device via wired or wireless connection and may use a power source (e.g., a battery or a USB connection to the device).

Electronic devices (e.g., computing devices) are becoming more mobile and portable. Individuals like to travel with their electronic devices and use external input devices such as a mouse or a track pad. However, the size of the mouse or track pad may make it cumbersome for travel. In addition, the input device may consume battery life of the device if physically connected, or the user may travel with additional batteries.

In addition, the components within the input device may fail over time. Thus, there may be costs associated with replacing the input device every few years. Moreover, the input devices may come in different sizes and shapes. The input devices may not fit or be comfortable to different users with different hand sizes. In addition, the input devices may take storage space and add weight when the user is traveling.

The present disclosure provides an electronic device that has a virtual input device. The electronic device may include at least one sensor that can detect a user's hand and movements of the user's hand that mimic an input device (e.g., a mouse or track pad). The device may translate or interpret the detected movements of the user's hand to an input for the electronic device. For example, the movement may be translated into movement of a cursor, a selection, calling a particular menu, scrolling through a document, and the like. As a result, the user may have full functionality of an input device without having to have a physical input device.

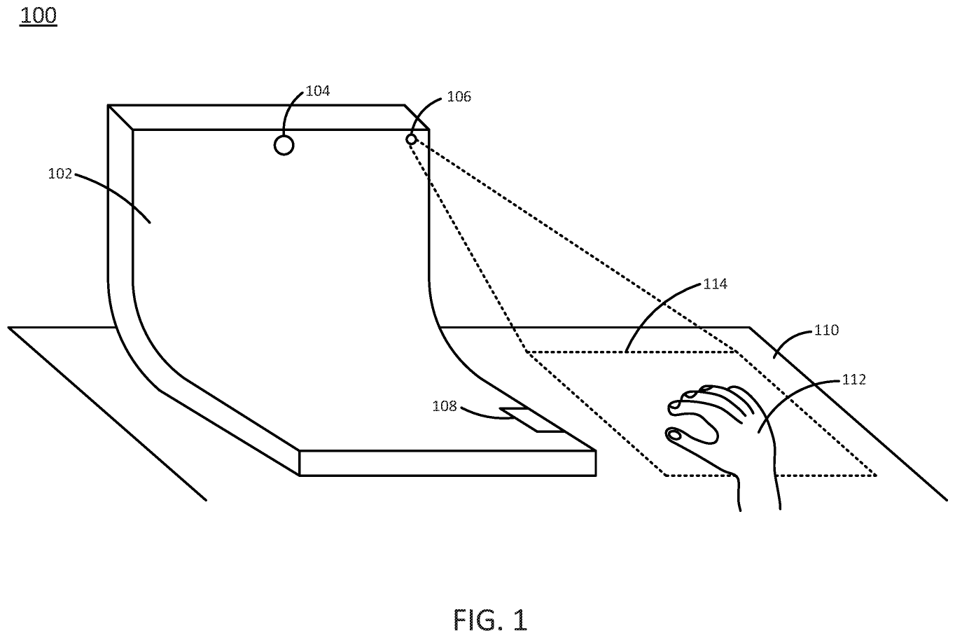

FIG. 1 illustrates an example an electronic device 100 of the present disclosure. In one example, the electronic device 100 may be any type of computing device such as a tablet, a desktop computer, an all-in-one computer, a laptop computer, and the like.

The electronic device 100 may include a display 102 and at least one sensor 104. In some examples, the electronic device 100 may include more than one sensor, such as a sensor 108. The sensor 104 may be a video camera (e.g., a red, green, blue (RGB) camera), a digitizer, an optical scanning component, a depth sensor, and the like. The sensor 108 may be a motion sensor or a proximity sensor that can detect the presence of a hand 112 of a user. Although sensors 104 and 108 are illustrated in FIG. 1, it should be noted that additional sensors may be used that also may be located in a variety of different locations on and around the housing of the electronic device 100.

In one example, the sensor 106 and/or 108 may be used to detect motion and interpret the correct directionality of the hand 112 of the user. The sensor 106 and/or 108 may detect the overall motion of the hand 112, movement of individual fingers of the hand 112, and the like. The sensor 106 and/or 108 may detect movement of the hand 112 and the electronic device 100 may translate the movements into a control input that is executed by the electronic device 100.

For example, if the sensor 106 is a video camera, the video camera may capture video images of the hand 112. Each frame of the video image may be analyzed to detect hand pixels. A motion vector may be associated with each hand pixel to detect movements of the hand 112 from one video frame to the next. Each motion vector of the hand pixels may be also analyzed frame-to-frame to detect movement of individual fingers of the hand 112. The movement of the hand 112 may be translated into a control input.

In another example, the sensor 108 may be a motion sensor. The motion sensor may detect general movements of the hand 112 (e.g., moving away from the sensor, towards the sensor, parallel with the sensor, and so forth). The movements detected by the motion sensor may be used to determine a general movement of the hand 112. The sensor 106 may work with the sensor 108, and possibly with other components not shown, to then correctly determine the movements of the fingers.

As noted above, other sensors may be included that work together to detect the movement of the hand 112. For example, a microphone may be used to detect a sound when a user taps on a surface 110. In one example, a tap sensor may be used on the surface 110 to detect the taps. A digitizer or an optical scanning component may scan the hand 112 of the user and create a three dimensional model of the hand 112 that can be shown on the display 102. The user may then view how the hand 112 is moving on the display 102.

In one example, a proximity sensor may detect when the hand 112 is near the electronic device 100 (e.g., within a boundary 114). The proximity sensor may automatically enable a virtual input device mode when the hand 112 is detected near the electronic device 100 or within a predefined area (e.g., the boundary 114). In one example, the virtual input device mode may be entered via a user selection on a graphical user interface (GUI) that is shown on the display 102.

For example, the movement of the hand 112 may mimic movements and controls that would be used with a physical input device, such as a mouse or track pad. For example, the hand 112 may be positioned as if the hand 112 is holding a mouse or moving on a trackpad. In one example, a dummy mouse (e.g., a wood or plastic block in the shape of a mouse) may be held in the hand 112 of the user.

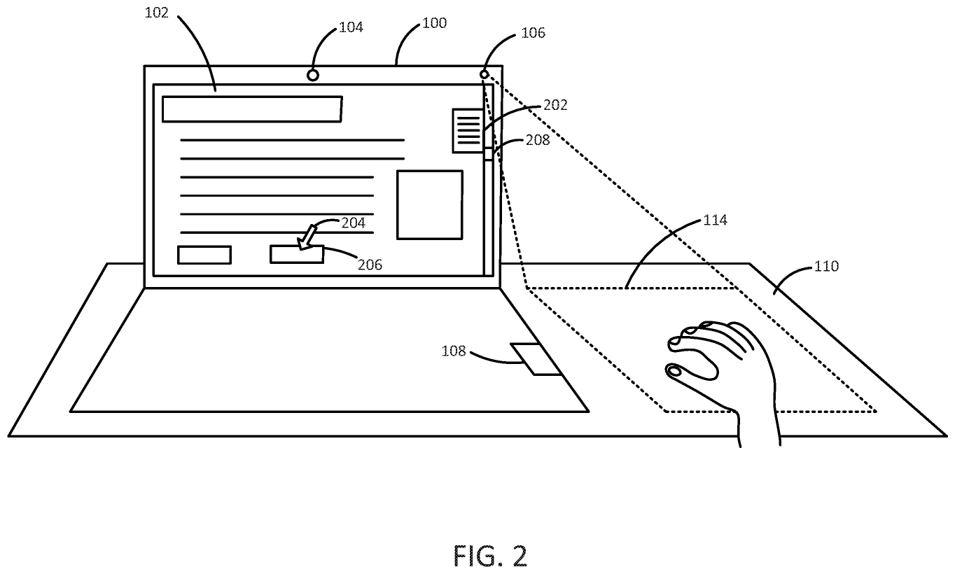

In one example, the control inputs may include inputs such as a single click, a double click, a right click, a scroll movement, a forward action, a backward action, and the like. FIG. 2 illustrates an example operation of the electronic device 100 with the virtual input device.

In one example, a movement of the hand 112 may control a cursor 204 or pointer that is shown on the display 102. For example, moving the hand 112 to the right may cause the cursor 204 to move to the right. In one example, cursor 204 may also move at the same speed as the speed of movement of the hand 112.

In one example, a movement of an index finger may indicate a single click. The single click may cause a selection to be made on a button 206 to make a selection. A quick double movement of the index finger may indicate a double click. A movement of a middle finger may indicate a right click that may cause a menu 202 to pop-up on the display 102. In one example, an up and down motion of the index finger may indicate a scroll movement to control a scroll bar 208 on the display. A movement of the thumb may indicate a back action (e.g., go back a page on a web browser). A movement of a pinky may indicate a forward action (e.g., go forward a page on the web browser), and so forth.

In one example, the above movements are provided as examples. Other finger motions, movements, and the like may be associated with different control inputs. In addition, the finger motions and movements may be different for right handed users and left handed users.

As a result, the electronic device 100 may allow a user to use a “virtual” input device to control operations of the electronic device 100. In other words, motions of the hand 112 are not used to control a virtual image. Rather, the motions of the hand 112 are used to mimic similar movements that would be used on a physical input device, such as a mouse or on a track pad, but with the physical device. The sensors 106 and/or 108 may be used to detect the movements of the hand 112. The electronic device 100 may then translate the movements that are detected into the control inputs to control operations on the electronic device 100.

Enabling the ability to use a “virtual” input device may allow a user to travel with the electronic device 100 without a physical input device. Moreover, the user may position his or her hand in any position that is comfortable. Thus, if the user is more comfortable holding a larger mouse, the user may have the hand 112 more open. For a smaller “virtual” device, the user may have the hand 112 more closed, and so forth. In addition, with the “virtual” input device there may be no parts to break, no batteries to replace, and so forth. Lastly, the “virtual” input device may be used on any surface.

Referring back to FIG. 1, the electronic device 100 may include a projector 106. The projector 106 may project a light onto the surface 110 (e.g., a table top, a desktop, a counter, and the like). The light may define the boundary 114 for the user. The boundary 114 may provide a visual for where the sensor 104 and/or 108 may be directed or focused to detect the hand 112 of the user. Thus, the user may know an area to move his or her hand 112 where the sensor 106 and/or 108 may correctly capture the movement of the hand 112. For example, if the hand 112 is moved outside of the boundary 114, the movements may be outside of the field of view of the sensor 106 or outside of the range of detection for the sensor 108. As a result, sensors 106 and/or 108 may be unable to capture movements of the hand 112 when moved outside of the boundary 114.

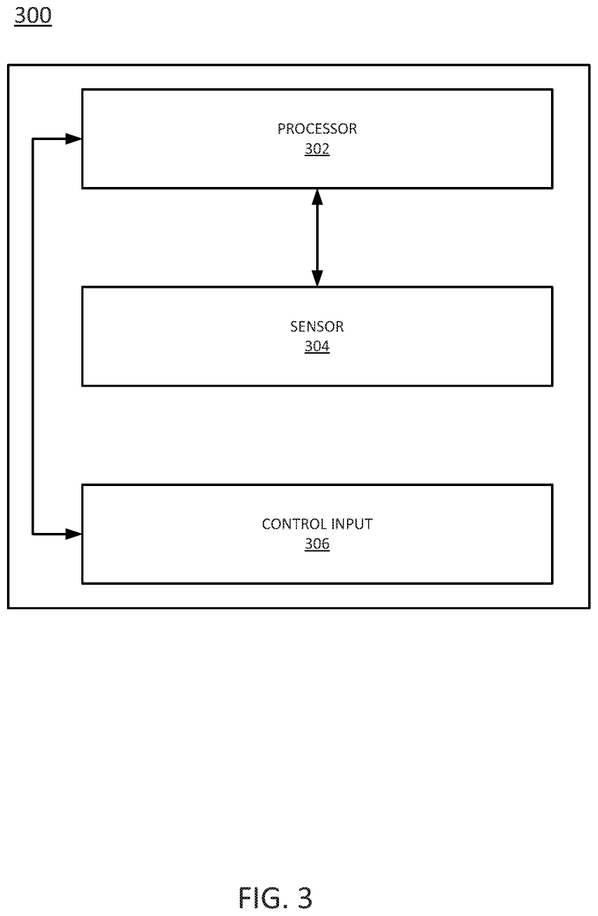

FIG. 3 illustrates a block diagram of an electronic device 300 that may enable a virtual input device. In one example, the electronic device 300 may include a processor 302 and a sensor 304. The processor 302 may be communicatively coupled to the sensor 304.

In one example, the sensor 304 may be used to detect a movement of the hand 112 that is mimicking movements associated with a physical input device. In other words, the sensor 304 may detect a “virtual” input device held by the hand 112 of the user. As noted above, the sensor 304 may include a combination of sensors that work together to detect the movement of the hand 112. For example, the sensor 304 may be a video camera, a digitizer, a motion sensor, a proximity sensor, a microphone, a tap sensor, or any combination thereof.

The processor 302 may translate the movement of the hand 112 of the user detected by the sensor 304 into a control input 306. The processor 302 may execute the control input 306 associated with the movement to control operation of the electronic device 300. The control inputs 306 may be stored in a non-transitory computer readable medium of the electronic device 300. As noted above, the control inputs may include a single click, a double click, a right click, a scroll movement, a forward action, a backward action, and the like.

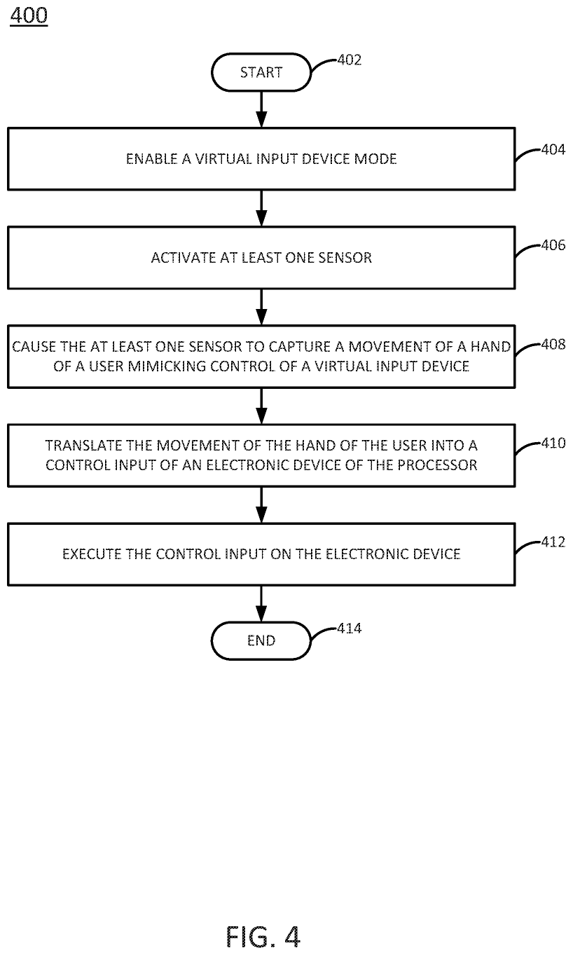

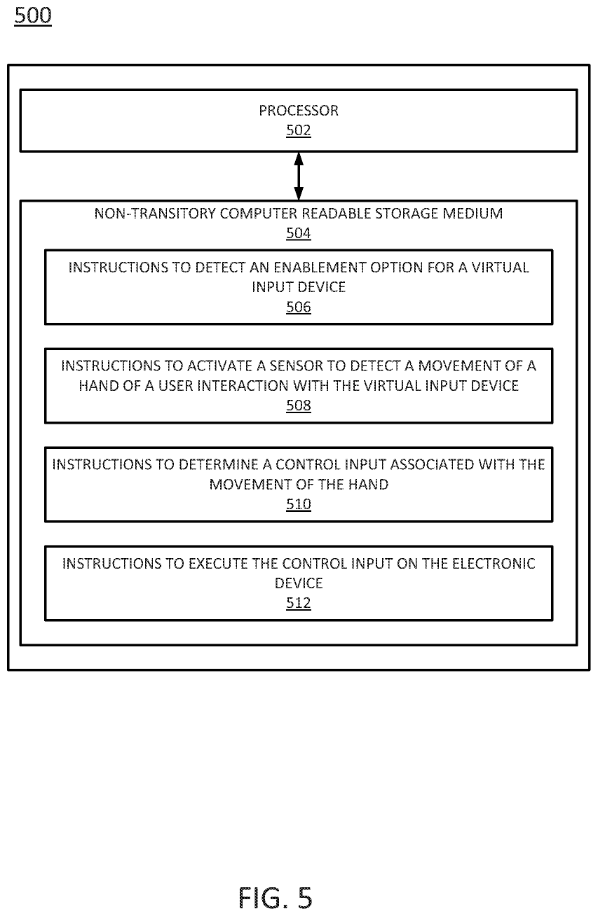

FIG. 4 illustrates a flow diagram of an example method 400 for operating a virtual input device. In an example, the method 400 may be performed by the electronic device 100, 300, or the apparatus 500 illustrated in FIG. 5, and discussed below.

At block 402, the method 400 begins. At block 404, the method 400 enables a virtual input device mode. In one example, the electronic device may automatically enable the virtual input device mode when the presence of a hand of the user is detected by a proximity senor. In one example, the presence of the hand may be within a predefined area or distance from the proximity sensor. For example, the hand may be detected within a boundary that can be defined by a projected light onto a surface. In one example, the virtual input device mode may be enabled via a user selection on a GUI shown on the display of the electronic device.

In one example, the user may have an option to further define the virtual input device mode. The user may select the type of virtual input device that he or she may be mimicking. For example, the user may select a mouse virtual input device mode or a touch pad virtual input device mode. The type of virtual input device mode that is selected may define the types of movements that the sensors are looking to track and/or define the control inputs that are associated with each movement.

At block 406, the method 400 activates at least one sensor. In response to the virtual input device mode being enabled, at least one sensor may be activated. For example, the sensor may be a video camera. When the virtual input device mode is enabled, the video camera may begin recording video images within a boundary or predefined area.

As discussed above, the electronic device may include one sensor or multiple sensors that can work together. For example, the sensor may be a video camera, a digitizer, a motion sensor, a proximity sensor, a microphone, a tap sensor, or any combination thereof.

At block 408, the method 400 causes the at least one sensor to capture a movement of a hand of a user mimicking control of a virtual input device. For example, when the sensor is a video camera, the sensor may detect movement of the hand via analysis of frames of the video image that are captured. In one example, a microphone may detect audible noises associated with a finger tapping a surface to detect a clicking action. In one example, a proximity sensor may detect a relative movement of the hand that moves closer to, further away from, or in parallel with the proximity sensor, and so forth.

The movements that are being detected may be movements that mimic movements used on an input device. For example, the user may have the hand in a position holding an imaginary or virtual mouse. In one example, a dummy mouse may be held. The movements that are being detected may be movements that simulate pressing a left button, double clicking a left button, clicking a right button, scrolling a scroll wheel, and so forth. Thus, the movement that are being tracked may not be any general hand or finger movements, but rather specific movements that would be used on a physical input device.

At block 410, the method 400 translates the movement of the hand of the user into a control input of an electronic device of the processor. For example, the control input may be a control input such as a single click, a double click, a right click, a scroll movement, a forward action, a backward action, or any combination thereof. The control input may be used to control some portion of the display or functionality of the electronic device.

At block 412, the method 400 executes the control input on the electronic device. For example, if the control input is to move a cursor to the right, the electronic device may move the cursor on the display to the right. In one example, if the control input is to bring up a menu, the electronic device may cause a menu to be displayed, and so forth. At block 414, the method 400 ends.

FIG. 5 illustrates an example of an apparatus 500. In an example, the apparatus 500 may be the electronic device 100 or 300. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include instructions to detect an enablement option for a virtual input device. The instructions 508 may include instructions to activate a sensor to detect a movement of a hand of a user interacting with the virtual input device. The instructions 510 may include instructions to determine a control input associated with the movement of the hand. The instructions 512 may include instructions to execute the control input on the electronic device.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An electronic device, comprising:
a sensor to detect a movement of a hand of a user controlling a virtual input device; and
a processor communicatively coupled to the sensor, wherein the processor is to translate the movement of the hand of the user detected by the sensor into a control input to the electronic device and to execute the control input.

2. The electronic device of claim 1, wherein the sensor comprises a video camera.

3. The electronic device of claim 2, further comprising:
a projector to illuminate an area that defines a field of view of the video camera that defines an area where the movement of the hand of the user can be detected.

4. The electronic device of claim 1, wherein the sensor comprises at least one of: a video camera, a digitizer, an optical scanning component, a motion sensor, a proximity sensor, a microphone, or a tap sensor.

5. The electronic device of claim 1, wherein the virtual input device comprises a mouse or a track pad.

6. The electronic device of claim 1, wherein the control input associated with the movement of the hand comprises a movement of a cursor on a display.

7. The electronic device of claim 1, wherein the movement of the hand comprises a movement of a finger of the hand.

8. The electronic device of claim 7, wherein the control input associated with the movement of the finger of the hand comprises at least one of: a single click, a double click, a right click, a scroll movement, a forward action, or a backward action.

9. A method, comprising:
enabling, by a processor, a virtual input device mode;
activating, by the processor, a sensor;
causing, by the processor, the sensor to capture a movement of a hand of a user mimicking control of a virtual input device;
translating, by the processor, the movement of the hand of the user into a control input of an electronic device of the processor; and
executing, by the processor, the control input on the electronic device.

10. The method of claim 9, wherein the enabling is performed via a user selection on the electronic device.

11. The method of claim 9, wherein the causing comprises:
scanning, by the processor, the hand;
mapping, by the processor, the hand to a coordinate system; and
determining, by the processor, an orientation of the hand within the coordinate system.

12. The method of claim 11, further comprising:
detecting, by the processor, a tapping motion of a finger of the hand.

13. The method of claim 9, wherein the causing comprises:
recording, by the processor, a video image of the hand; and
processing, by the processor, the video image to determine the movement of the hand.

14. A non-transitory computer readable storage medium encoded with instructions executable by a processor of an electronic device, the non-transitory computer-readable storage medium comprising:
instructions to detect an enablement option for a virtual input device;
instructions to activate a sensor to detect a movement of a hand of a user interacting with the virtual input device;
instructions to determine a control input associated with the movement of the hand; and
instructions to execute the control input on the electronic device.

15. The non-transitory computer readable storage medium of claim 14, wherein virtual input device comprises a mouse and the movement of the hand comprises actions associated with interacting with the mouse.
